(19) United States
(12) Patent Application Publication
(10) Pub. No.: US 2014/0147825 A1
(43) Pub. Date: May 29, 2014

(54) DIGITAL CLASS MANAGEMENT SYSTEM

(71) Applicant: Michael G. Xakellis, Lake Forest, IL (US)

(72) Inventor: Michael G. Xakellis, Lake Forest, IL (US)

(21) Appl. No.: 14/092,379

(22) Filed: Nov. 27, 2013

Related U.S. Application Data
(60) Provisional application No. 61/730,222, filed on Nov. 27, 2012.

(51) Int. Cl. G09B 5/02

(52) U.S. Cl. CPC G09B 5/02
USPC 434/350

(57) ABSTRACT

A digital class management system including a server and a client device in communication with the server. The client device is displays a digital document stored on the server to a user where the digital document includes text, images, and white space. An input communicates with the server so that movements of the input relative to the client device causes the display device to display the movements on the digital document.

### BACKGROUND

This invention relates generally to a method, software and computer program product for use in education, and specifically to a digital classroom management system that enhances interaction between users, such as teachers, students and parents, for improving the students' engagement and learning.

Advances in technology have transformed our society from a primarily paper-based society to a more digital or computer-based society. Many people now have laptop or notebook computers, personal digital assistants (PDAs) or “smart” phones that enable users to access information, such as e-mails or other documents, from virtually anywhere in the world. Schools and other educational establishments are capitalizing on this advancement in technology. Traditionally, schools have used primarily paper-based educational tools in the classroom. Much of the instruction and student activities use handwritten or scanable tests, quizzes and worksheets.

In recent years, classroom lectures, lesson plans, assignments, quizzes and tests are being stored on secure websites accessible by students, teachers and parents using a password. Providing such access to students' grades, assignments and tests allows teachers and parents to be able to monitor a student's progress and provide differentiated instruction to those students.

Presently, there are many digital resources available to promote student assessment and learning. For example, classroom lectures or other educational videos can be uploaded to web-based video sites such as YouTube® or similar sites. Online access allows teachers to be able to upload assignments to a website for students to complete online or download and work on at home. In this regard, digital content can be stored on a website for use by students, teachers or parents. Digital documents can be sent to students by e-mail, stored in a drop box, stored on flash drives or printed out by a user. Although access to these documents is enhanced, managing and organizing these digital documents still poses a big challenge for teachers.

Accordingly, there is a need for a digital classroom management system and computer program product that enables educational providers to organize and manage classroom documents and data for their students.

### SUMMARY

The present digital management system is directed to a method, software and computer program product that enables users, such as teachers, students and parents, to interact with each other and documents in the system to enhance education of the students.

In one embodiment, a digital class management system is provided that includes a server and a client device in communication with the server. The client device displays digital documents stored on the server to a user where the digital document includes text, images, and white space. An input communicates with the server so that movements of the input relative to the client device cause the display device to display the movements on the digital document. More specifically, user input to the client device changes the displayed document and are also communicated to the server and saved to the stored version of the document on the server.

In another embodiment, white space in the digital document expands to accommodate user input. When the user types in additional text or makes pen stroke movements those inputs are added to the existing document, expanding whitespace as necessary. This is most common when the new content is adjacent to at least one of text and a bottommost portion of the digital document.

In a further embodiment, a method of digitally managing classroom is provided and includes providing a server, providing a client device in communication with the server, displaying a digital document stored on the server to a user on an output device, the digital document including text, images, and white space and communicating with the server using an input, wherein movements of the input relative to the client device causes the client device to display the movements on the digital document.

### BRIEF DESCRIPTION OF THE FIGURES

FIG. 1 is a web page displayed by the digital class management system that allows teachers to upload a document and instructions associated with the document.

FIG. 2 is a web page displayed by the digital class management system including an assignment/task list for a student's classes.

FIG. 3 is a web page displayed by the digital class management system to a student of their assignment from the list of FIG. 2 having a plurality of algebra problems and the student's work and solution for each problem.

FIG. 4 is a web page displayed by the digital class management system showing the compiled list of assignments from FIG. 2 including grades for the assignments in the list.

FIG. 5 is a web page displayed by the digital class management system to the teacher of the student's completed assignment of FIG. 3 that has been accessed by a teacher for grading and adding comments to the assignment.

FIG. 6 is a web page displayed by the digital class management system including the assignment of FIG. 3 that has been graded by the teacher and accessed by the student or the student's parents for reviewing and accessing the student's performance on the assignment.

FIG. 7 is a web page displayed by the digital class management system including pen input and a digital document where a user writes directly on the digital document using the pen input.

FIG. 8 is the web page displayed by the digital class management system in FIG. 7 where the white space has been expanded between “Question 1” and “Question 2” to accommodate for larger text written on the digital document by the user.

FIG. 9 is the web page displayed by the digital class management system in FIG. 7 where users have written on the digital document using different pen colors.

### DETAILED DESCRIPTION

The present method and computer program product provides an educational system configured to manage a “digital classroom” where teachers, parents and students have access to the digital classroom. The digital classroom provides a single location, such as a secure website, that is accessible by the teachers, the parents and the students so that each are able to view and evaluate the students' educational progress in a particular class or classes.

On the digital classroom site, teachers can upload lessons, lectures, quizzes, tests, assignments and other documents for students to complete online and then turn in for grading. It should be appreciated that other educational resources can also be provided on the digital classroom website such as essays, book reports and other types of papers. Providing assignments and other educational resources online allows teachers the ability to manage their classroom 24 hours a day and also allows teachers to be able to work directly with each student on an individual basis.

Regarding document management, teachers upload or create digital documents on the digital classroom site that can be accessed by their students. Digital documents, such as homework assignments, are assigned to some or all of the students via a work queue. The students access the assignments in the work queue and can work online or print the assignments. The students can access the assignments or other documents using a school provided computer or a personal computer such as an iPad® or a home desktop or laptop computer. It is also contemplated that the students can access and complete the documents using a cellular phone, PDA or similar device. After students turn in assignments or papers, teachers can access the assignment or paper online, review it, mark it up and provide a grade. The students and parents can then review the graded assignment. This process can also be performed for quizzes, tests and other assessment tools.

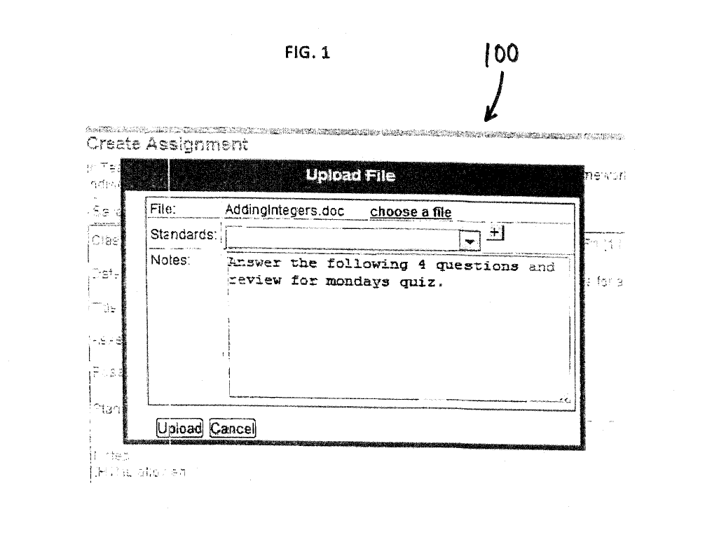

Initially, teachers can re-use existing homework assignments/worksheets, quizzes, tests, etc. to upload to the digital classroom site 100 as shown in FIG. 1. In the future, the uploaded documents can be used or revised as needed. In another embodiment, the worksheets, assignments, quizzes, tests or other documents are created online and stored or saved on the website.

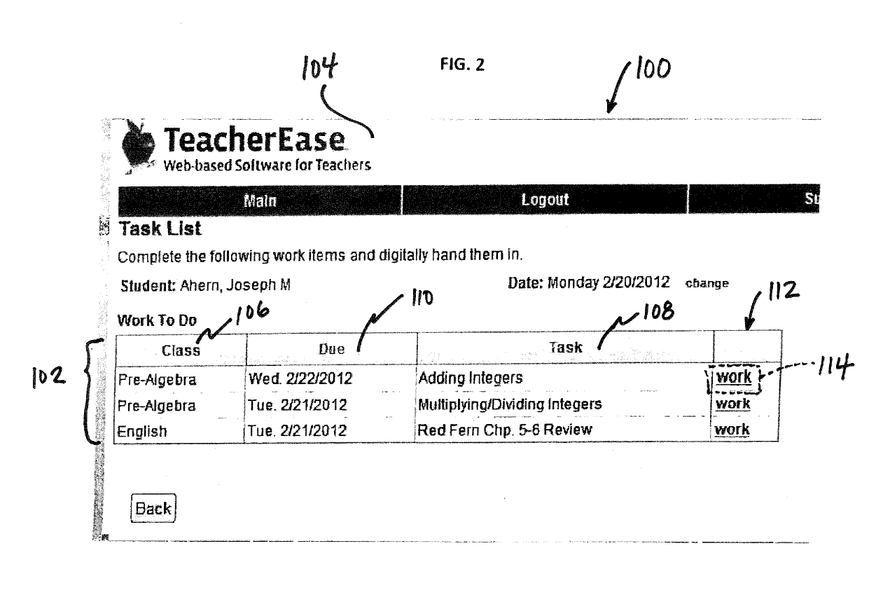

Referring now to FIG. 2, the digital classroom website 100 provides a student task or assignment list 102 that allows a student to manage their class responsibilities. For example, the website screen 104 displays the task/assignment list 102 including a student's class 106, one or more tasks or assignments for that class 108 and the date 110 that the task or assignment is due. The task list 102 also includes a column 112 with a link 114 that provides direct access to a particular assignment or task so that the student can work on it online or download and open the assignment. After completing the assignment, the student can then electronically submit the work online or upload work that was previously downloaded to indicate to that it has been completed. It should be appreciated that any suitable educational resource may be uploaded and integrated into the task list such as assignments, quizzes, tests and research papers.

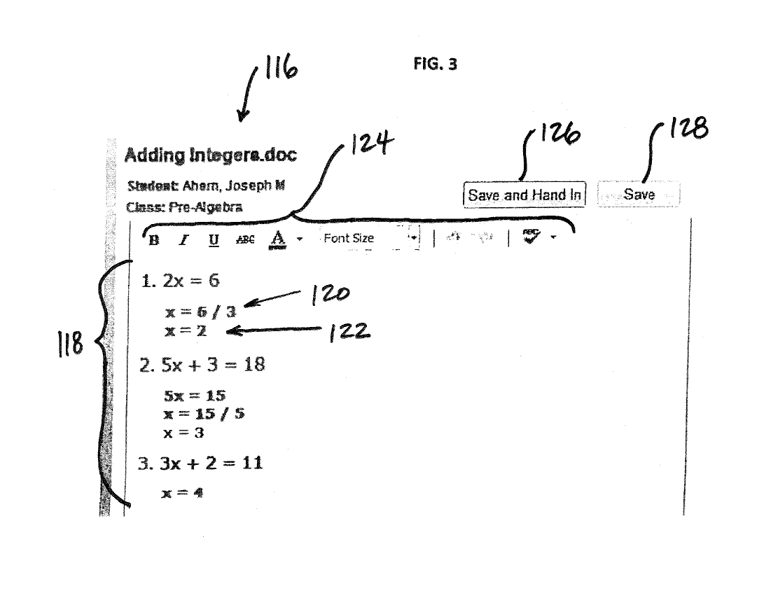

Referring now to FIG. 3, an example of a digital document 116 that has been uploaded and accessed by a student is shown. The digital document 116 can be downloaded for rich applications that reside only on the client device, or accessed and worked on online. In this example, a student is working on an assignment for pre-algebra as indicated in the upper left hand corner of the screen. The assignment includes a series of algebra problems 118. The student uses a keyboard or similar input device to type in their work 120 and the solution 122 to each problem directly on the screen. This enables a teacher to see the student's thought processes in solving the problem and also the solution achieved by the student. The digital document 116 also includes conventional editing functions or inputs 124 such as bolding, italics, underlining and font size. After the student has completed the worksheet or assignment, the student clicks on an input button 126 entitled “Save and Hand-In.” This action saves the student's work on the website and digitally indicates that the student has completed the particular assignment. The screen also includes an input 128 entitled “Save” that allows a student to save their work as they are working on the worksheet. This feature allows the student so save their work so that they can work on an assignment on different days and/or at different times if needed. When the student has completed the assignment, the student clicks on the “Save and Hand In” button 126 by using the keyboard, a mouse or other suitable input device. It should be appreciated that other inputs may be employed on the website to save and store assignments.

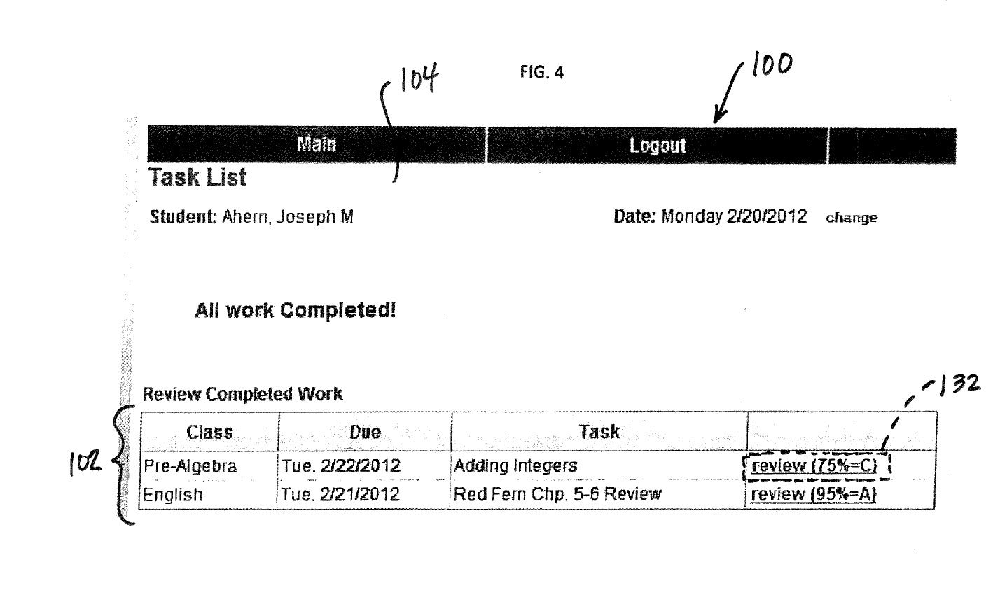

Referring now to FIG. 4, after an assignment has been completed, the digital classroom website 100 displays an indicator 130 that the student has completed all of their assignments or work on the task/assignment list 102. For example, the website screen 104 shown in FIG. 4 indicates that the student has “All Work Completed!” The teacher can then access the site 100 and review the student's work and provide feedback and grades for the particular assignments. In this example, the student received a 75% or “C” on the pre-algebra assignment of FIG. 3 and a 95% or “A” on an English assignment. A student can click on the link 132 associated with the grades to access those particular assignments and see the basis for the grades and the teacher's comments if any. Alternatively, the assignment or task list 102 can include a separate column indicating the grade and another separate column that provides the link to the completed assignment or task.

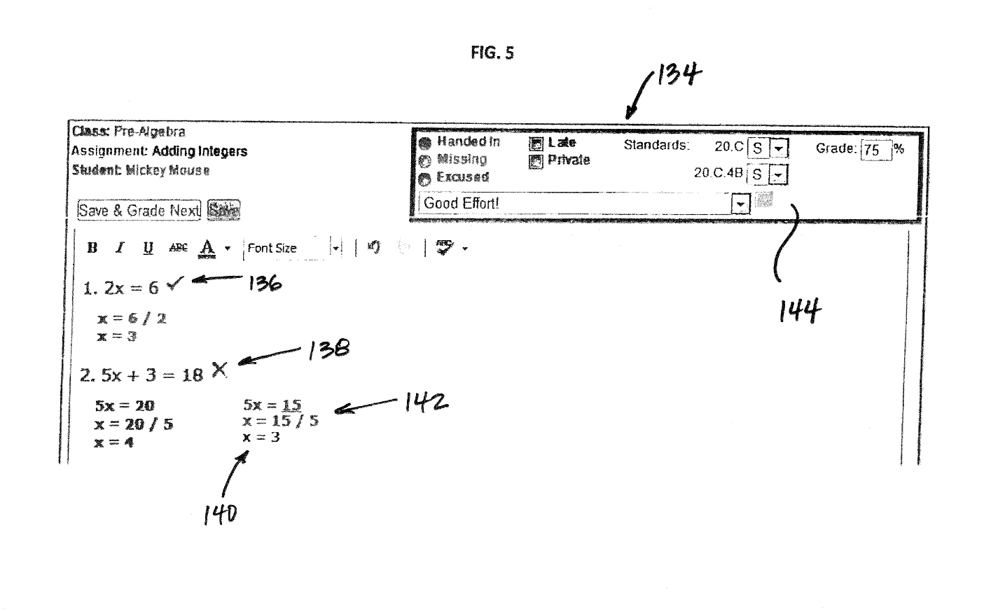

Referring now to FIG. 5, teachers can access the student's work on the digital classroom website 100 so that they can review, provide feedback and grade the task or assignments as described above. FIG. 5 shows a teacher's webpage or screen 134 after they have opened a student's completed assignment. The teacher reviews the assignment and enters a mark or indicator 136, such as a checkmark or other suitable indicator, if the solution to the problem is correct, or a different indicator 138 such as an “X” or other suitable indicator to indicate that the solution to the problem is incorrect. The teacher then can type in the correct solution 140 and solution strategy 142 as shown on the screen to show the student the correct solution and strategy for solving the problem. The teacher's page 134 also includes an area 144, such as the boxed area on the top right of the screen, that allows the teacher to provide a status of an assignment such as “Handed In,” “Missing,” “Excused,” “Late” or “Private.” This area 144 also includes pre-loaded or pre-designated grading standards for a particular assignment, the grade and other comments such as “Good Effort!” as shown on the screen. It should be appreciated that other indicators may be employed on the teacher's site to assist the teacher in providing feedback to a student.

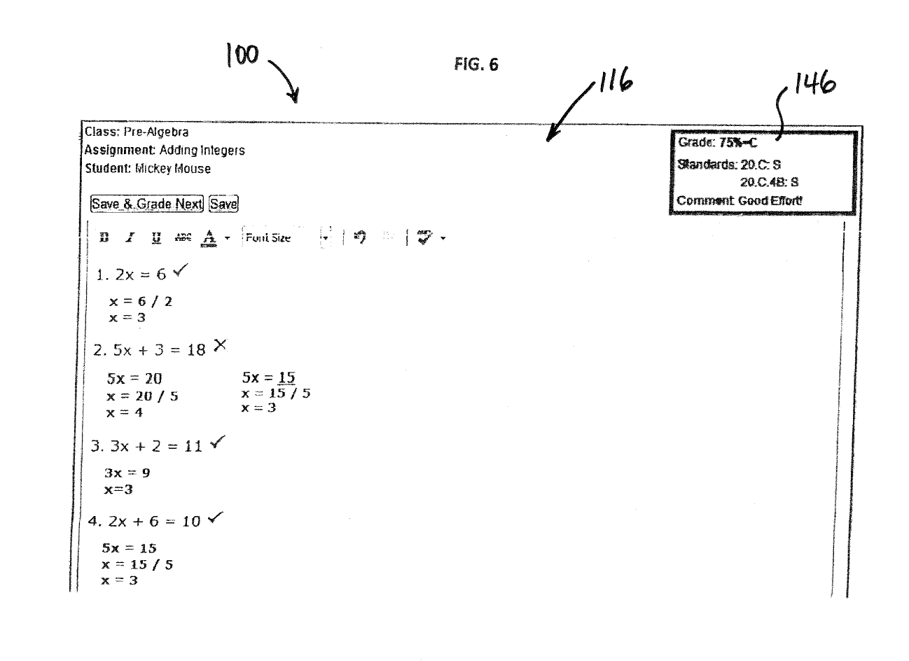

Referring to FIG. 6, after the task or assignment has been graded by the teacher, students and parents can access the digital document 116 including the graded assignment to review it. The box 146 in the upper right hand corner of the screen displays the student's grade, the standards and the teacher's comments discussed above. It should be appreciated that other assessment indicators and/or comments can be displayed on the screen. In this way, a student and parent can review the student's assignment and understand the student's strength and weaknesses in a particular subject or class. It is contemplated that the digital classroom website 100 may also include a link to the teacher's email or other link to correspond with the teacher, so that the parents, students and teacher can communicate with each other about a student's educational assessment and learning abilities.

In the above embodiments, the present digital classroom website/software stores all of a student's curriculum, activities/assignments and resources for each of their classes. The teachers access and provide lesson plans for a particular class or for each student based on their educational needs. Also, the school district's education standards, the state's education standards or other related standards (such as the Common Core Standards) can be implemented and integrated into the digital classroom to easily track each student's progress in their classes. The website/software is also configured to analyze teachers' and students' activities and make suggestions for additional learning methods and assignments.

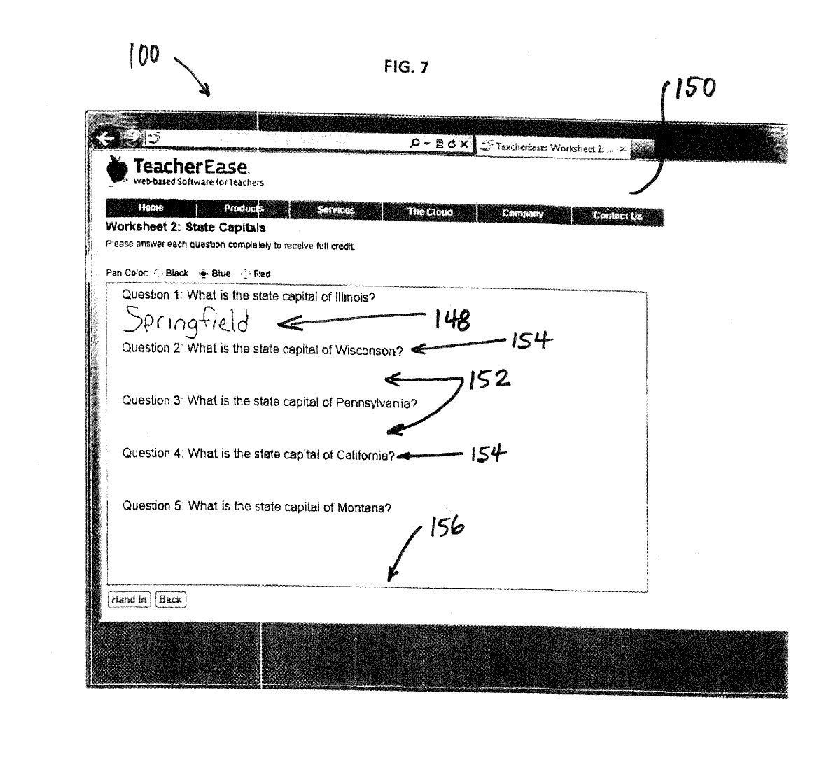

Referring now to FIGS. 7-9, the digital class management system includes a “pen input” (not shown) or a computer input, such as a mouse, finger, or pen-like stylus, enables users to handwrite answers and other work directly on a web page 100 via a user's personal computing device such as a laptop or desktop computer, PDA or “smart” phone. The pen input is performed on an existing document that has been uploaded to the digital class management system or website, much like a student writes on a paper-based worksheet. This is accomplished by overlaying any canvas element such as an HTML5, SVG, Adobe Flash, or ActiveX canvas on the original assignment (or loading the original assignment into the canvas), capturing input movements as the student writes a response and using those movements to graphically display pen strokes 148 as writing in the student's work document or worksheet 150 in the digital class management system.

The capture method or user input includes, but is not limited to, mouse events (i.e., mouseup, mousedown, mousemove, mouseout), touch events (i.e., touchstart, touchmove, touchend), and stylus events (i.e., stylusdown, stylusmove, stylusup, stylusleave). The events used vary based upon the technical platform. A down event such as “mousedown” sends a signal to the canvas to enter drawing mode and begin capturing coordinates. Some circumstances that would generate a down event are when a stylus comes in contact with the tablet, the screen is touched, or a mouse button is held down. Once in drawing mode, the canvas will capture new coordinates sent from move events such as “mousemove.”

Move events are generated when a stylus/finger moves across the tablet screen while already in contact with the screen, or a mouse moves on the screen. If the canvas receives an up or leave event such as “mouseup” or “mouseout,” the drawing mode will end and coordinate capture will stop until a new down event is received. An up event is generated when the stylus is lifted from the screen, and a leave event is generated when the tip of the stylus is no longer within the bounds of the canvas. FIG. 7 shows an example of student handwriting captured on a worksheet 150 electronically distributed by a teacher.

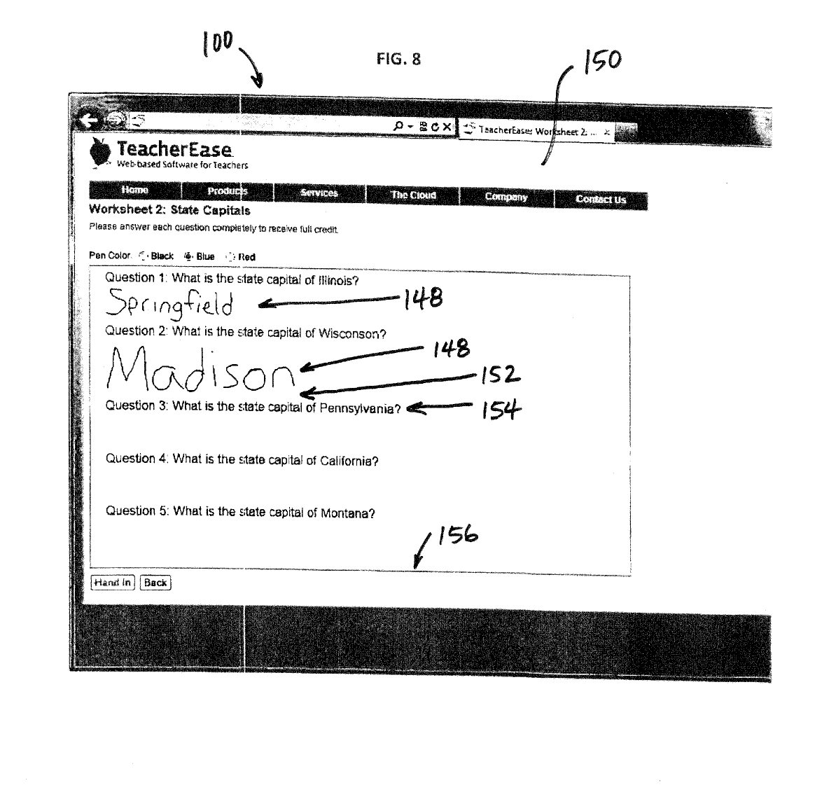

Another feature of the digital class management system is handling situations where students run out of vertical white space 152 (i.e., writing space on the document displayed on the screen) when writing. The underlying document is automatically stretched or lengthened to provide more white space for the student or other use to write when they get too close to adjacent text 154 on the assignment/document or the bottommost portion 156 of the assignment/document displayed on the screen. The method for providing additional white space 152 includes, but is not limited to, the same events listed above (plus explicit requests to the user interface). This requires the canvas to perform simple collision detection. In FIG. 8, the system provides more white space 152 to the user, i.e., student, in the second question to accommodate a larger answer written by the user.

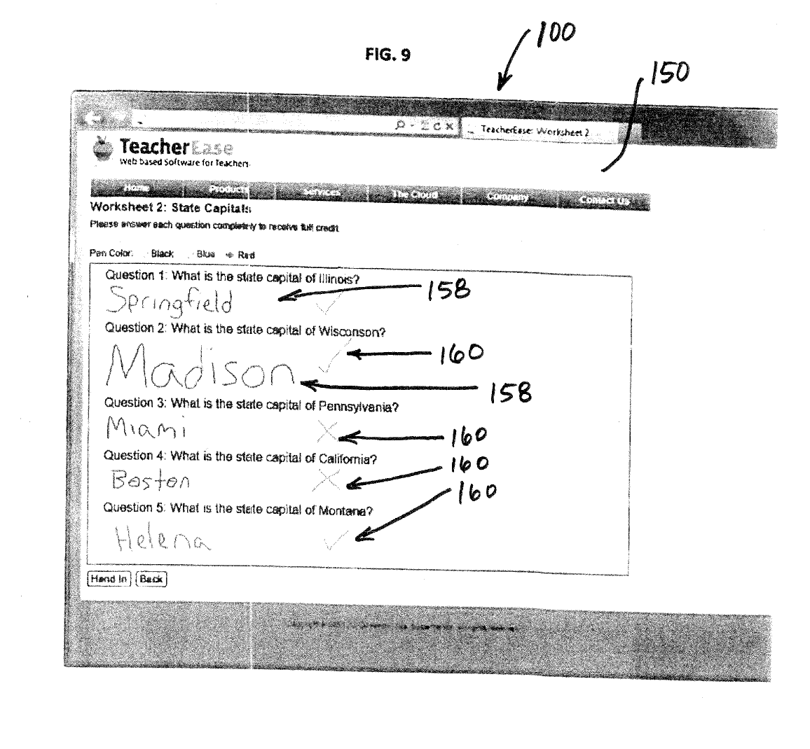

Once students are finished with their assignment, they digitally hand it in for the teacher to grade as discussed above. Typically, a teacher will mark up the assignment using a different color pen than the student. The canvas allows the user to select different color pens. In an embodiment, the default color or first color 158 for the student's pen is always different than the default color or second color 160 of the teacher's pen. It should be appreciated that one pen color or several pen colors may be used by each user. This functionality makes it easy for the teacher and student to distinguish between any marks and/or comments written on the assignment or other document as shown in FIG. 9.

While particular embodiments of the present digital management system have been shown and described, it will be appreciated by those skilled in the art that changes and modifications may be made thereto without departing from the invention in its broader aspects and as set forth in the following claims.

What is claimed is:

1. A digital class management system comprising:
a server;
a client device in communication with said server, said client device configured to display a digital document stored on said server to a user on an output device, said digital document including text, images, and white space;
an input in communication with said server, wherein movements of said input relative to said client device causes said client device to display said movements on said digital document.

2. The digital class management system of claim 1, wherein said white space in said digital document expands when said movements of said input are adjacent to at least one of text, an image, or a bottommost portion of said digital document.

3. The digital class management system of claim 1, wherein said white space in said digital document has a designated dimension and said white space expands when said movements of said input in said white space are greater than said dimension.

4. The digital class management system of claim 1, wherein said input includes at least one of a mouse and a stylus.

5. The digital class management system of claim 1, wherein movements of said input include at least one of mouse events, touch events and stylus events.

6. The digital class management system of claim 1, wherein said input generates a designated color on said digital document when said input is moved relative to said client device.

7. The digital class management system of claim 1, further comprising a plurality of inputs, wherein a first input of said plurality of inputs generates a first color on said digital document when said first input is moved relative to said client device and a second input of said plurality of inputs generates a second color on said digital document when said second input is moved relative to said client device.

8. The digital class management system of claim 6, wherein said first color and said second color are different colors.

9. The digital class management system of claim 1, wherein said output device includes a display or a computer screen.

10. A method of digitally managing classroom assignments comprising:
providing a server;
providing a client device in communication with said server;
displaying a digital document stored on said server to a user on an output device, said digital document including text, images, and white space;
communicating with said server using an input, wherein movements of said input relative to said client device causes said client device to display said movements on said digital document.

11. The method of claim 10, which includes expanding said white space when said movements of said input are adjacent to at least one of text, an image, or a bottommost portion of said digital document.

12. The method of claim 10, wherein said white space in said digital document has a designated dimension and said white space expands when said movements of said input in said white space are greater than said dimension.

13. The method of claim 10, wherein movements of said input include at least one of mouse events, touch events and stylus events.

14. The method of claim 10, which includes generating a designated color on said digital document when said input is moved relative to said client device.

15. The method of claim 10, which includes generating a first color on said digital document when a first input is moved relative to said client device and generating a second color on said digital document when said second input is moved relative to said client device.

16. The method of claim 15, wherein said first color and said second color are different colors.
